(19) United States
(12) Patent Application Publication
(10) Pub. No.: US 2007/0170614 A1
(43) Pub. Date: Jul. 26, 2007

(54) Method and device for extrusion pressing of bent extruded profiles

(75) Inventors: Joachim Ohlberg, Mühlheim (DE); Markus Konig, Dusseldorf (DE); James Camp, Bonn (DE); Wilfried Geven, Neuss (DE); Uwe Muschalik, Duisburg (DE)

Correspondence Address: K.F. ROSS P.C., 5683 RIVERDALE AVENUE, SUITE 203 BOX 900, BRONX, NY, 10471-0900, US

(73) Assignee: SMS EUMUCO GMBH, Leverkusen (DE)

(21) Appl. No.: 10/570,234

(22) PCT Filed: Aug. 18, 2004
(86) PCT No.: PCT/DE04/01832

§ 371 Date: Jan. 4, 2007

(30) Foreign Application Priority Data
Sep. 2, 2003 (DE) 103 40 772.3

(51) Int. Cl. B29C 47/00

(52) U.S. Cl. 264/151; 264/210.2; 264/285; 264/295; 425/232; 425/325; 425/308; 700/196

(57) ABSTRACT

The invention relates to a method for extruding curved extruded profiles. The extruded profile (9) is formed in a matrix (4) mounted upstream in a counter beam (6) of an extruder system (1) and is subsequently curved or bent due to the effect of external forces and separated, supported and arranged into partial lengths in the extrusion flow by means of a separating robot connected to a higher control mechanism (12) and is discharged to a storage area (15) with the aid of a handling robot. The handling robot (14) is coupled to the separating robot (10) by means of the control mechanism (12) and, like said separating robot, is moved into a starting position in front of an extrusion press (1), wherein it assumes a maintenance position downstream from the separating robot (10), whereupon it moves together with the separating robot (10) into a final separating position (13) in a synchronous manner with respect to the beginning of the separating process, whereupon it supports and assumes the pressed extruded profile section (9) following the predetermined pressway thereof, whereupon the separating robot (10) returns to its original position for renewed synchronisation with the pressed extruded profile (9) and the handling robot (14) transports the separated partial length, deposits it (15) and subsequently returns to its maintenance position. A handling robot (14) is arranged downstream from the separating robot (13) in such a way that it covers the working area from at least the final separating position (13) to a depositing device (15). Said handling robot (14) comprises means (17) used to support a separated partial length of the extruded profile section.

The invention regards a method and a device for extrusion pressing of bent extruded profiles, the extruded profile being shaped in a die positioned in front of an cross beam of an extruding press and being subsequently bent or bent off by external forces acting on it, as well as cut into sections while moving by means of a cutter connected to an overhead controller, carried off on a conveyor and transferred to a storage area with the help of a handling robot.

Regarding the production of rounded extruded profiles required in the most different industrial areas for the most different purposes and primarily composed of aluminum and magnesium alloys, it is known from EP 0706843 B1 that for extrusion pressing of hollow products with large variations in wall thickness a force is applied with a pusher (guide tool) on a profile at such a spacing from the die output end or cross beam that there is an effect on the profile shaped in the extrusion die. The pusher can be a roller, a slide surface generating a transverse force, a ball assembly or a similar tool. The conversion into the bent or curved extruded profile is carried out downstream of the extrusion tool in the region where the material can be plastically deformed.

These extruded profiles are continuously bent to one side according to a given radius or alternatingly are bent in both directions and are then separated into the sections required, e.g. by sawing or flame cutting and moved downstream thereafter. For this purpose a method and device of the initially described kind are known from DE 101 41 328 A1. It provides a raisable and lowerable table provided in the press output area, supporting the extruded profile, and separated into function fields, the front field close to the machine being followed by a rear field that can be temporarily pivoted into a position tilted to the base. The front function-field always remains in its position, basically supporting the profile and due to its stationary position is there to support the following extruded profiles, while the rear function field that can be pivoted downward provides for the transfer of the separated profile lengths.

As soon as the required section is cut off, the rear function field is lowered so that this section can glide from the support. Then it can be gripped by a handling robot and transferred to an output roller conveyor. Until the rear function field pivots back up into its supporting position, the following extruded profile is supported only by the front function field. On the one hand, the extruded-profile sections can be thus individualized so that there is enough free space for the continuously following profiles and on the other hand, each following profile can be supported again, or respectively still be supported. Damage to the surface of the extruded profile, however, due to relative movement between the support surface and the supported extruded-profile section cannot be excluded, a fact that is even aggravated by the conversion heat.

Therefore it is the object of the invention to create a method and device as described above with improved operational characteristics.

Regarding a method, this object is attained according to the invention by coupling the handling robot with the cutter by means of the controller and by moving them into an upstream starting position in front of the extruding press, in which the handling robot is situated in an upstream waiting position immediately downstream of the cutter, then, with the start of the separation procedure, is moved together with and synchronously to the cutter, thereby supporting the extruded profile and following its precalculated extrusion path with the cutter to the downstream separation end position, from which the cutter moves back into its starting position with the extruded profile for resynchronization with the extruded profile, while the handling robot transports the separated section to the storage area, deposits it there and is subsequently moved back to its upstream waiting position. Thus an automated, technically synchronized process can be achieved that guarantees that variously bent extruded profiles cut into lengths are transported after the separation procedure from the separation area to the storage area without any relative movement and therefore without any damages to the profile. This way, both the continuously extruded profile and the extruded-profile sections formed after cutting are carefully supported during the transport, the extruded-profile sections not being gripped or clasped, i.e. are not exposed to any mechanical strain.

One embodiment of the invention therefore provides that the support brought into the extrusion path temporarily holds up the extruded profile when the handling robot is moved to the storage area and subsequently to its upstream starting and waiting position.

The invention proposes that the transferred sections are cooled on their conveying path to the storage area. This is carried out on the conveyor path and allows a cooling down of the extruded-profile sections to any desired temperature, prior to further handling or prior to the placing in storage.

Regarding the apparatus, the object of the invention is solved according to the invention by the fact that a. handling robot is provided downstream of the cutter and is effective in a work area extending at least from the cutting end position to a transfer device provided with a transfer device for supportedly receiving a separated extruded-profile section. In the first phase, the extruded profile moves with the cutter by means of the controller such that synchronized movements are ensured and, after the final cut-through, preferably by a saw blade of the cutter, is supported and transferred to the transfer device that is also synchronized with the movements of the extruded profile, and further transported.

The transfer device-can be advantageously designed as a fork with several tines to for an adjustable and easily modified transfer device surface that can be adjusted to the profile or to its curve. Thus, even profiles that are complicated and three-dimensionally bent, can be transported without damage. This is facilitated by the fact that the handling robot is coupled to the cutter by means of the controller and follows the precalculated movements or respectively extrusion paths of the profile in the same way the sawing robot does, without moving relative to the extruded profile.

It contributes to careful conveyance when the carrying surfaces, that is the surfaces of the tines, are provided with a heat-resistant layer, e.g. Kevlar.

For the temporary support during transportation carried out by the handling robot from the extruding press or the work area of the cutter, a raisable and lowerable support, such as rollers, can be advantageously arranged in the extrusion path.

The invention proposes that the transfer device consists of several continuously running belts that are set parallel to one another. This way, gentle transfer and careful transport of the still hot, separated extruded-profile sections lying flat on the belts is guaranteed.

According to one embodiment of the invention, a cooling conveyor is arranged downstream of the transfer device, preferably also consisting of several continuously running belts that are set parallel. Alternatively, an output table or the like can be added, the cooling conveyor or the output table being adjusted to actual needs and variable with respect to shape. The geometry of the cooling section is independent of the proceedings in the region of the cutting and handling robots.

It is preferably proposed that the transfer device and the cooling conveyor are made as modules. This section can be easily expanded in breadth and length. Thereby e.g. a cost-saving output variant for certain profiles can be at any time converted into an expanded variant for a wider profile spectrum.

The cooling conveyor, which could also be designed as a cooling tunnel, advantageously is provided with elements for pumping in a cooling agent. Adequate elements are blowers, air and/or water nozzles or the like, arranged above the cooling conveyor.

According to one embodiment of the invention, the end of the cooling conveyor is provided with a tilting device for standing up the extruded-profile sections, the extruded-profile sections thus being immediately-brought into an erect stacking position for the following storage.

The automated process chain for cutting, cooling and storing separated bent extruded-profile sections can be further improved by providing a stacking robot followed by a stacking transfer device downstream of the cooling conveyor. According to one embodiment of the invention, the stacking robot has a gripping arm provided with an image recognition means. The image recognition means ensures that the gripping arm or a different adequate gripping system is before the transfer already in a position adjusted to the curve of the extruded-profile sections.

When preferably the cutter, the handling robot-and the stacking robot are mounted overhead the whole work area particularly in front of the extruding press cross beam remains empty and therefore freely accessible and useable.

Further features and details of the invention are seen in the claims and the following description of an illustrated embodiment of the invention shown in the drawings. Therein:

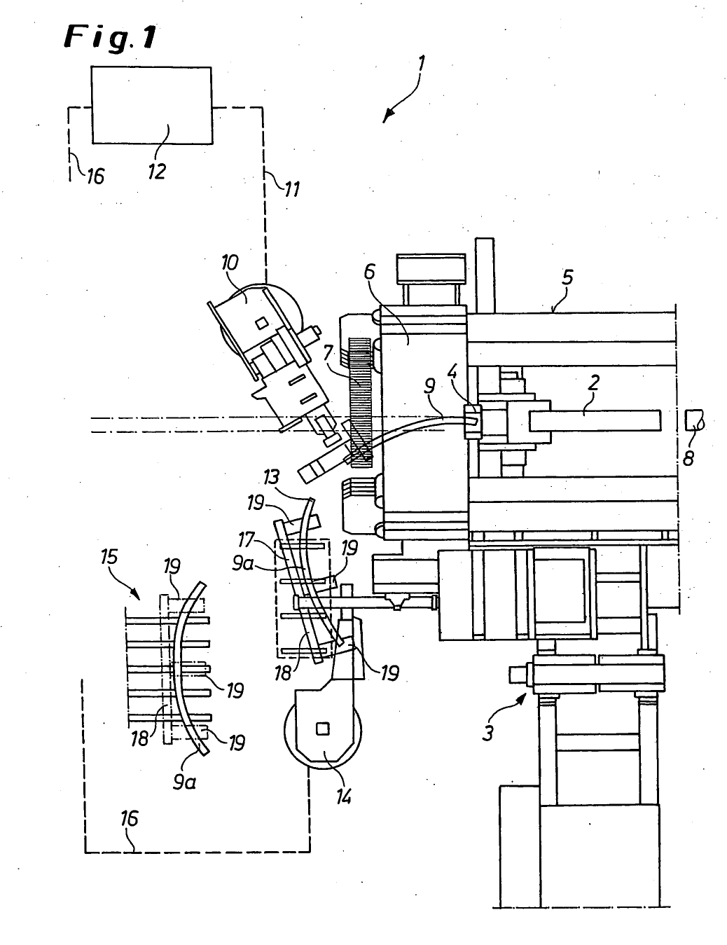

FIG. 1 is a top view of an extruding press for the production of bent extruded profiles with robots provided in the output area;

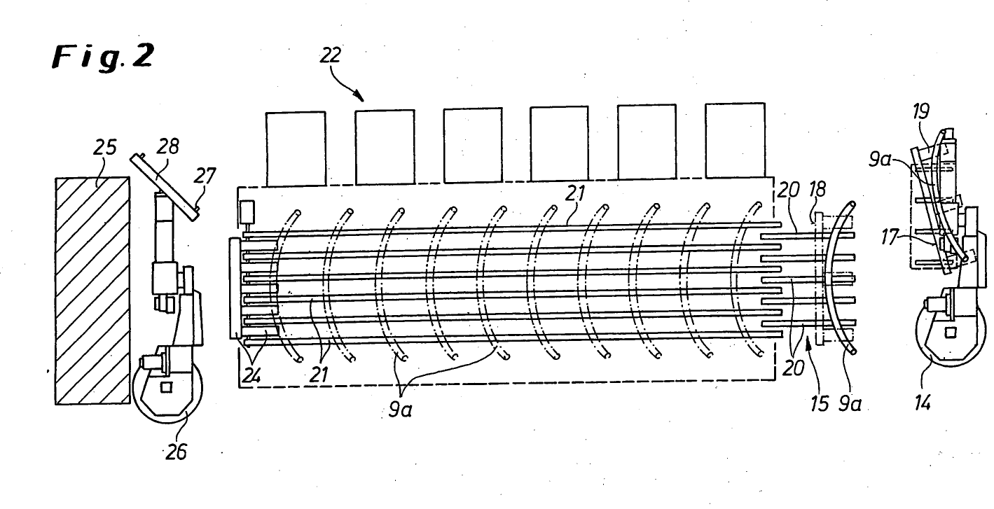

FIG. 2 is a top view of a transfer device as a detail of the output area of the extruding press according to FIG. 1 with a downstream cooling conveyor and an extruded-profile transfer device;

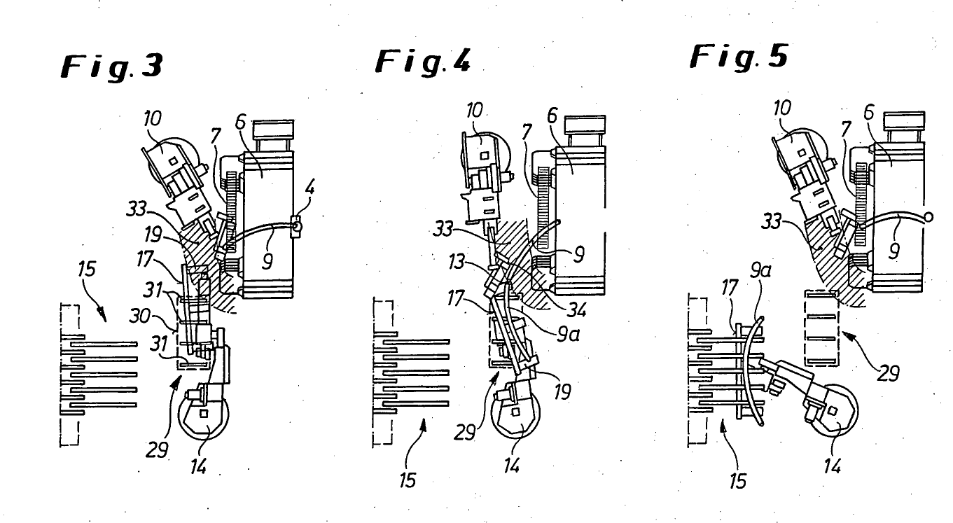

FIG. 3 is the extruding press as a detail of FIG. 1 with the downstream robots moved into their starting positions;

FIG. 4 is a view according to FIG. 3, here showing subsequent positions of the robots; and

FIG. 5 is a view according to FIGS. 3 and 4 showing a further different position of the robots.

In an extrusion pressing apparatus as shown in FIG. 1 a billet 2 to be extruded is transported by means of a billet loader 3 upstream of a shaping die or tool 4 of an extruding press 5, of which basically only the cross beam 6 and a guide tool 7 arranged at the output side of the extruding press are illustrated. An extruded profile 9 made extruded by means of a extrusion pusher bar 8 forcing the billet 2 through the die or tool 4, moves downstream from the cross beam 6 and is bent while moving by means of the guide tool 7 into the curve or radius required.

Downstream in the extrusion direction downstream of the guide tool 7 is a cutter 10 that is connected by a control line 11 to an overhead control unit 12, that in the illustrated embodiment is designed as a sawing robot, and that cuts the extruded profile 9 into bent extruded-profile sections 9a. The cutter 10 is moved synchronously with the predetermined, precalculated movements of the extruded profile 9 by means of the control unit or controller 12, so as to move downstream together with the extruded profile 9 until the final cut-through is carried out and terminated in the separation end position 13. A handling robot 14 moved here in its waiting position then engages under the separated extruded-profile. section 9a and transports it to a transfer device 15 for storage. Like the cutter 10, the handling robot 14 is connected to the overhead controller 12 via a control line 16 and consequently is also synchronized with the movements of the extruded string prdfile 9 or of the extruded-profile section 9a.

For a careful transfer and transport of the separated extruded-profile sections 9a the handling robot 14 covering the whole work area at least from the transfer device 15 to the separation end position 13 is provided with a transfer device 17 in the form of a fork 18 that in the illustrated embodiment has three tines 19. These tines might be covered with a heat-resistant layer and support the extruded-profile section 9a from below without any relative movement to carry the extruded-profile section 9a lying down to the transfer device 15 and deposit it there.

The transfer device 15 here consists of several parallel and continuously running belts 20 leading to a cooling conveyor 22, which also consists of several parallel and continuously running belts 21, and carrying the extruded-profile section 9a to the belts 21, as shown in FIG. 2. The cooling conveyor 22 has a row of overhead cooling blower units 23. At the end of the cooling conveyor 22 a tilting device 24 is provided that stands up the extruded-profile sections 9a before they are set on a storage shelf 25. For the transfer of the erected extruded-profile sections 9a from the tilting device 24 to the storage shelf 25 a stacking robot 26, which has a gripping arm 28 withan image recognition means 27, is provided.

FIGS. 3 to 5 show different operational sequences of the process cycle. With the start of the extrusion pressing of an extruded profile 9 both the cutter 10 and the handling robot 14, which is in a waiting position adjacent the hatched work area 33 of the cutter 10, are in their starting positions. A support 29 in the form of several rollers 32 mounted in a frame 30 following the work area of the cutter 10 is in a lower position not obstructing the path of the handling robot 14 with its transfer device 17. As soon as the extruded profile 9 leaves the cross beam 6 and is bent into a curved shape by the guide tool 7 as required, the cutter 10, which is coupled by means of the controller or control unit 12 (see FIG. 1) such that its movements are synchronized with the movements of the extruded profile 9, moves with the profile or its cut line 34 into the separation end position 13, as shown in FIG. 4.

The extruded profile 9 or the extruded-profile section 9a is thus positioned on the transfer device 17 of the handling robot 14 in its waiting position. The handling robot 14 with its transfer device 17 has also been moving synchronously. The handling robot 14 with its transfer device 17 moves from the operating position according to FIG. 4 out of the work area 33 and deposits the extruded-profile section 9a in the transfer device 15, as shown in FIG. 5. The cutter 10 has already moved back into its starting position according to FIG. 5 in order to be synchronized with the movement of the continuously extruded profile 9 for the next cut-through.

While the handling robot 14 moves, the support 29 according to FIG. 5 is raised and during this time supports the extruded profile 9 outside the work area 33. It is lowered when the handling robot 14 is moved back and reassumes the support and transfer of the extruded profile 9 or of the extruded-profile section 9a. This alternation with automated process cycle for cutting, cooling and storing extruded profiles 9 or extruded-profile sections 9a is repeated until the useful mass of the billet 2 to be extruded is used up and restarts with the loading and extrusion of a new billet.

1. A method for extrusion pressing of bent extruded profiles, where the extruded profile is shaped in a die situated in front of an cross beam of an extruding press, is subsequently bent or bent off by external forces acting on it as well as cut into sections while moving by means of an automatic cutter connected to an overhead controller, carried off on a conveyor, and transferred to a storage area with the help of a handling robot, characterized in that the handling robot (14) is coupled via the controller (12) to the automatic cutter (10) and is moved like the latter into a starting position upstream of the extruding press (5) where it takes a waiting position downstream of the automatic cutter (10), then, at the start of the cutting procedure, is moved together and synchronously with the automatic cutter (10), thereby supportedly taking over the extruded profile (9) and following the precalculated extrusion path with the automatic cutter (10), into the separation end position (13), from which the automatic cutter (10) moves back into its starting position for resynchronization with the extruded profile (9) while the handling robot (14) transports the separated extruded-profile section (9a) to the storage area, deposits it there and is subsequently moved back into its waiting position.

2. The method according to claim 1, characterized in that a support (29) brought into the extrusion path of the extruded profile (9) temporarily supports the extruded profile (9, 9a).

3. The method according to claim 1, characterized in that the deposited extruded-profile sections (9a) are cooled on their transport path to the storage area.

4. An apparatus for extrusion pressing of bent extruded profiles, the extruded profile being shaped in a die upstream of an cross beam of an extruding press and subsequently bent or bent off by external forces acting on it, as well as cut into sections while moving by means of an automatic cutter connected to an overhead controller, carried off on a conveyor and transferred to a storage area with the help of a handling robot, particularly for carrying out the method according to claim 1, characterized in that, downstream of the automatic cutter (10), a handling robot (14) is situated in a work area (33) extending at least from the cutting end position (13) to a transfer device (15) provided with a carrier (17) for supportedly receiving a separated extruded-profile section (9a).

5. The device according to claim 4, characterized in that the carrier (17) is a fork (18) with several tines (19).

6. The device according to claim 4, characterized in that the carrying surfaces or surfaces of the tines (19) are provided with a heat-resistant layer.

7. The device claim 4, characterized in that raisable and lowerable support (29) is provided in the extrusion path of the extruded profile (9; 9a).

8. The device claim 4, characterized in that the transfer device (15) consists of several continuously running belts (20) that are spaced apart side by side parallel to one another.

9. The device claim 4, characterized in that a cooling conveyor (22) is situated downstream of the transfer device (15).

10. The device according to claim 9, characterized in that the cooling conveyor (22) is comprised of several continuously running belts (21) that are arranged side by side in parallel distance.

11. The device claim 8, characterized in that the transfer device (15) and the cooling conveyor (22) are constructed as modules.

12. The device claim 9, characterized in that the cooling conveyor (22) has coordinated elements (23) for blowing in a cooling agent.

13. The device claim 9, characterized in that a tilting device (24) for erecting the extruded-profile sections (9a) is arranged at the end of the cooling conveyor (22).

14. The device according to claim 9, characterized in that downstream of the cooling conveyor (22) is provided a stacking robot (26) that is followed by a stacking transfer device (25).

15. The device according to claim 14, characterized in that the stacking robot (26) has a gripper arm (28) with an image recognition means (27).

16. The device claim 4, characterized in that the automatic cutter (10), the handling robot (14) and the stacking robot (26) are mounted overhead.
